(19) United States
(12) Patent Application Publication
(10) Pub. No.: US 2026/0361638 A1
(43) Pub. Date: Nov. 12, 2026

(54) METHOD AND SYSTEM FOR ROUTING PACKETS ACROSS MULTIPLE DIES USING ORIENTATION AWARE HIERARCHICAL IDENTIFICATION

(71) Applicant: SKYECHIP BERHAD, BAYAN LEPAS (MY)

(72) Inventors: Hooi Kar Loo, Bayan Lepas (MY); Yu Ying Ong, BAYAN LEPAS (MY); Eu Jin Lim, BAYAN LEPAS (MY)

(21) Appl. No.: 19/652,815

(22) Filed: Apr. 20, 2026

(30) Foreign Application Priority Data
May 9, 2025 (MY) PI2025002874

(51) Int. Cl. H04L 45/02; H04L 45/745

(52) U.S. Cl. CPC H04L 45/04; H04L 45/745

(57) ABSTRACT

A method for routing packets across multiple dies comprises assigning an interface identification (ID) and a local ID to a packet at a source node, wherein the local ID corresponds to a destination node within a destination die, and the interface ID is used to identify an inter-die interface for routing the packet; routing the packet to a receiving chiplet through the inter-die interface according to the interface ID; checking if the receiving chiplet is the destination die by comparing chiplet IDs of the receiving die and the destination die; and routing the packet to the destination node based on the routing information obtained. The present invention also discloses a system for routing packets across multiple dies.

### FIELD OF INVENTION

The present invention relates to a method and system for routing packets across multiple dies in a multi-die System on Chip (SoC). In particular, the present invention relates to a method and a system for routing packets across multiple dies using orientation aware hierarchical identification (ID).

### BACKGROUND

Network-on-Chip (NoC) has emerged as the preferred communication architecture in modern semiconductor systems, offering greater flexibility and scalability compared to traditional bus-based architectures. As the demand for increased processing power grows, multi-die architectures have been developed, where large chip designs are broken into smaller dies or chiplets, that are interconnected via inter-die interfaces forming multi-die System-on-Chip (SoC). This approach in chip design introduces new challenges in managing communication and routing between chiplets, ensuring efficient data transfer across multiple dies. With the growing prevalence of multi-die SoCs, the complexity of routing data packets between chiplets has increased, demanding advanced techniques for scalable and high-performance interconnects.

Conventional approaches to data routing within SoCs often relied on bus-based architectures or monolithic NoCs, where communication was limited to a single die. These methods typically used fixed routing tables and simple packet forwarding mechanisms to manage traffic between nodes. However, multi-die SoCs introduce two significant challenges for NoC routing and packet management. First, the number of source-to-destination node pairs grows exponentially with the number of dies, leading to a dramatic increase in the size of routing tables that track these pairs. Second, as the number of dies increases, the number of hops required for data transmission between source and destination nodes also grows exponentially, resulting in larger entries in the routing tables.

One example of a NoCs routing is as disclosed in U.S. Pat. No. 10,911,261B2 that provides a system on chip that includes multiple local networks, each with one or more local endpoints and a first router. Some of the local endpoints in different networks share non-unique port identifiers, while at least one global network with port identifiers for its global endpoints is connected to the local networks through transparent bridges and a second router.

Another example is found in CN114760255A which discusses an on-chip and inter-chip integrated network architecture for multi-bare-chip interconnections. The architecture utilizes an annular topology to interconnect multiple XY-dimensional Mesh networks, each responsible for data transmission within a single chip. The system employs two routing virtual channels and two message virtual channels to manage data flow, ensuring deadlock-free operation at both the routing and message levels.

As outlined above, various advancements have been developed to address these challenges. However, there is a need for more efficient and scalable methods of packet routing across multiple dies that address the exponential growth of routing tables and the increased complexity of inter-chiplet communication.

### SUMMARY OF INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

It is an objective of the present invention to provide a method and a system for routing packets across multiple dies using orientation aware hierarchical identification (ID).

One aspect of the present invention provides a method for routing packets across multiple dies, comprising the steps, assigning an interface identification (ID) and a local ID to a packet at a source node, wherein the local ID corresponds to a destination node within a destination die, and the interface ID is used to identify an inter-die interface for routing the packet, routing the packet to a receiving chiplet through the inter-die interface according to the interface ID and checking if the receiving chiplet is the destination die by comparing chiplet IDs of the receiving die and the destination die. If the receiving chiplet is not the destination die, using the interface ID of the packet to perform a lookup in an interface ID routing table, the table comprising ranges of Interface IDs and routing information for forwarding the packet to another inter-die interface, routing the packet to a subsequent receiving die based on the routing information obtained from the interface ID routing table and repeating the step of checking if the receiving die is the destination die. If the receiving die is the destination die, using the local ID of the packet to perform a lookup in a local ID routing table, the table comprising local IDs and routing information for delivering the packet to the destination node and routing the packet to the destination node based on the routing information obtained.

In an embodiment of the present invention, the interface ID comprises the chiplet ID for identifying the chiplet, a link ID for identifying an inter-die interface between chiplet on an edge of the chiplet.

In an embodiment of the present invention, the interface ID further comprises an edge ID for identifying the edge of the chiplet.

In an embodiment of the present invention, assigning the interface ID and the local ID to the packet is performed by any one of the methods selected from pin straps, fuses, firmware programming, or hardware table lookups.

In an embodiment of the present invention, the method is applicable for routing a packet from an initiator node to a target node and returning the packet from the target node to the initiator node.

Another aspect of the present invention provides a system for routing packets across multiple dies, comprising a plurality of chiplets, each interconnected by one or more inter-die communication interfaces, wherein each of the inter-die communication interfaces is identified by an interface identification (ID), a plurality of routers and nodes on each chiplet for receiving, forwarding, or routing packets, an Interface ID routing table associated with each router or node, comprising entries that map ranges of interface IDs to routing information for forwarding packets to inter-die communication interfaces and a local ID routing table, associated with each router or node, comprising entries that map local IDs to routing information for routing packets to destination nodes within the chiplet.

In an embodiment of the present invention, the interface ID comprises a chiplet ID for identifying the chiplet, an edge ID for identifying an edge of the chiplet, and a link ID for identifying an inter-die interface between chiplet on the edge of the chiplet.

In an embodiment of the present invention, the chiplet ID comprises two sub-identifiers, configured to denote coordinates of the chiplet within the system.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF ACCOMPANYING DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1a shows an interface ID assignment in a multi-die system composed of nine chiplets by using Universal Chiplet Interconnect Express (UCIe) as the inter-die protocol in accordance with an embodiment of the present invention;

FIG. 1b shows an alternative chiplet ID assignment scheme for the multi-die system composed of nine chiplets in accordance with an embodiment of the present invention;

FIG. 1c shows an inter-die interfaces in multi-die configurations without the edge IDs in accordance with an embodiment of the present invention;

FIG. 2 shows a local ID assignment in a multi-die system composed of three dies in accordance with an embodiment of the present invention;

FIG. 3 shows a transaction between two nodes residing in different chiplet in accordance with an embodiment of the present invention; and

FIG. 4 shows an interface ID of the response packet for alternate return paths in accordance with an embodiment of the present invention.

### DETAILED DESCRIPTION OF THE PREFERRED EMBODIMENTS

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely to provide a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

In this disclosure, the terms “chiplet” and “die” are used interchangeably to refer to individual semiconductor components fabricated on separate pieces of silicon. As the present invention pertains to a multi-die system on chip, the terms “chiplet” and “die” should be construed as referring to the same meaning for the discussion of the present invention.

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, several materials are identified as suitable for various facets of the implementations. These materials are to be treated as exemplary and are not intended to limit the scope of the invention.

The present invention relates to packet routing across multiple dies in a multi-die System on Chop (SoC). In particular, the present invention relates to a method and a system for routing packets across multiple dies using orientation aware hierarchical identification (ID).

In accordance with an embodiment of the present invention, a method for routing packets across multiple dies, comprising the steps, assigning an interface identification (ID) and a local ID to a packet at a source node, wherein the local ID corresponds to a destination node within a destination die, and the interface ID is used to identify an inter-die interface for routing the packet, routing the packet to a receiving chiplet through the inter-die interface according to the interface ID and checking if the receiving chiplet is the destination die by comparing chiplet IDs of the receiving die and the destination die. If the receiving chiplet is not the destination die, using the interface ID of the packet to perform a lookup in an interface ID routing table, the table comprising ranges of Interface IDs and routing information for forwarding the packet to another inter-die interface, routing the packet to a subsequent receiving die based on the routing information obtained from the interface ID routing table and repeating the step of checking if the receiving die is the destination die. If the receiving die is the destination die, using the local ID of the packet to perform a lookup in a local ID routing table, the table comprising local IDs and routing information for delivering the packet to the destination node and routing the packet to the destination node based on the routing information obtained.

The interface IDs serve to identify an inter-die interface amongst all other inter-die interfaces across all dies in a multi-die system. These interface IDs are composed of a chiplet ID, edge ID, and link ID. The chiplet ID identifies a specific die or chiplet in the multi-die system, the edge ID identifies an edge of a particular die, and the link ID identifies the inter-die interface on a particular die edge.

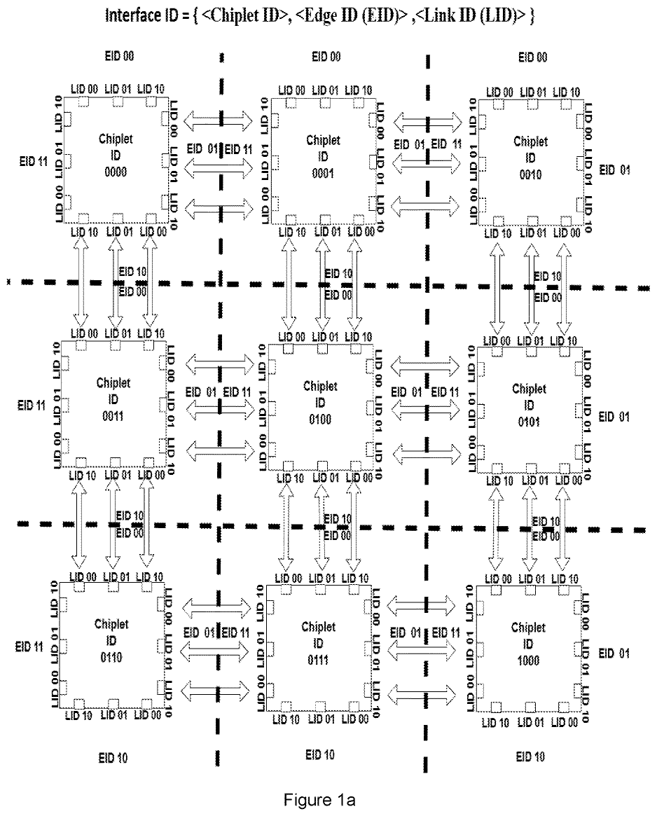

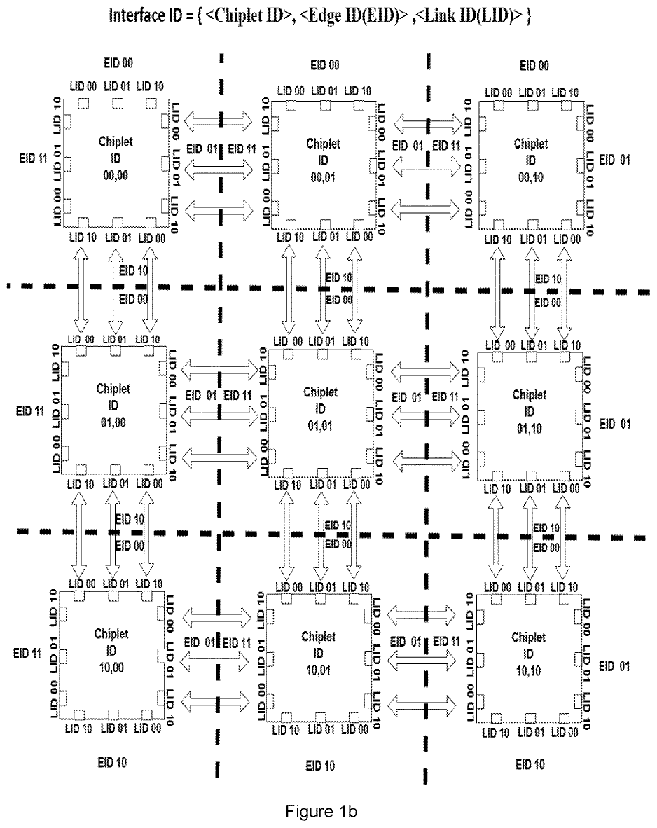

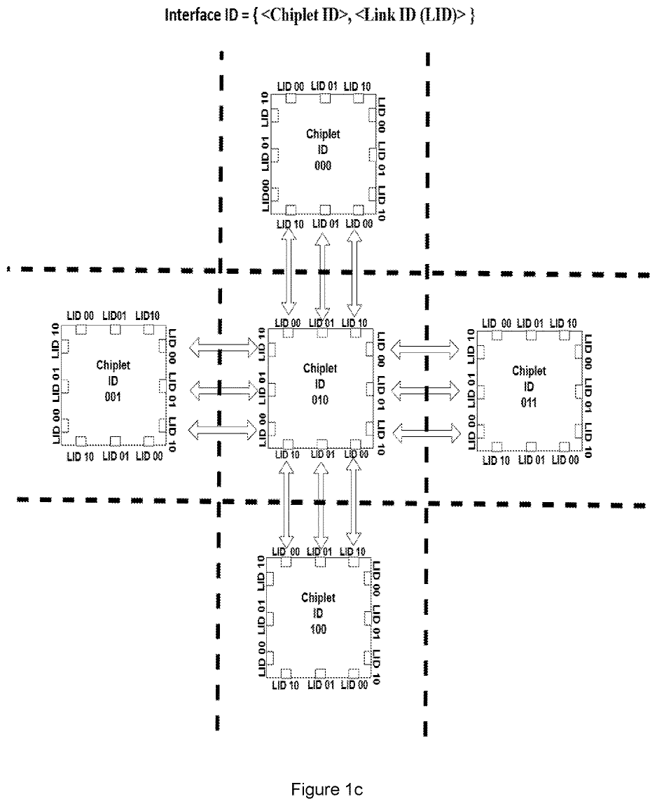

Reference is first made to FIG. 1a, which shows the interface ID assignment in a multi-die system composed of nine chiplets by using Universal Chiplet Interconnect Express (UCIe) as the inter-die protocol. The chiplet ID assignment, by way of a non-limiting implementation, uses sequentially increasing binary numbers, beginning with the top-left chiplet. However, the chiplet ID assignment scheme can be implemented by any method and is not limited to any specific implementations, so long as each die in the multi-die system is assigned a unique ID.

FIG. 1b shows the alternative chiplet ID assignment scheme for the multi-die system consisting of nine chiplets. Instead of using sequentially increasing binary numbers as shown in FIG. 1a, this scheme conceptually partitions the binary digits of the chiplet ID into two sub-IDs, which represent the row and column information, respectively. The multi-die system can be visualized as nine chiplets arranged in a 3×3 grid, and the sub-IDs within the chiplet ID specify the chiplet's position within this grid. This alternative scheme provides more detailed topological information, enabling better routing decisions and promoting greater reuse of routing entries. The edge IDs are useful in multi-die configurations where more than one die edge has inter-die interfaces as shown in FIG. 1b.

FIG. 1c shows the inter-die interfaces in multi-die configurations without the edge IDs in accordance with an embodiment of the present invention. The inclusion of edge IDs enables more precise routing decisions based on the specific die edge to which a packet is routed. These IDs can be omitted in configurations where they are not needed, as shown in FIG. 1c. In this configuration, chiplets with chiplet ID 000, 001, 011 and 111 have connected inter-die interfaces only on a single die edge. Additionally, the middle chiplet with chiplet ID 010 is accessible from neighbouring chiplets through a specific edge only. As a result, the interface ID can be optimized to chiplet ID and link ID only since edge IDs does not provide additional topological information necessary for routing decisions. This optimization conserves hardware resources by eliminating the need for edge ID data to be carried by inter-die packets traversing the NoC. While subsequent sections assume the presence of edge IDs, the described concepts are applicable to multi-die systems that choose to omit them as well.

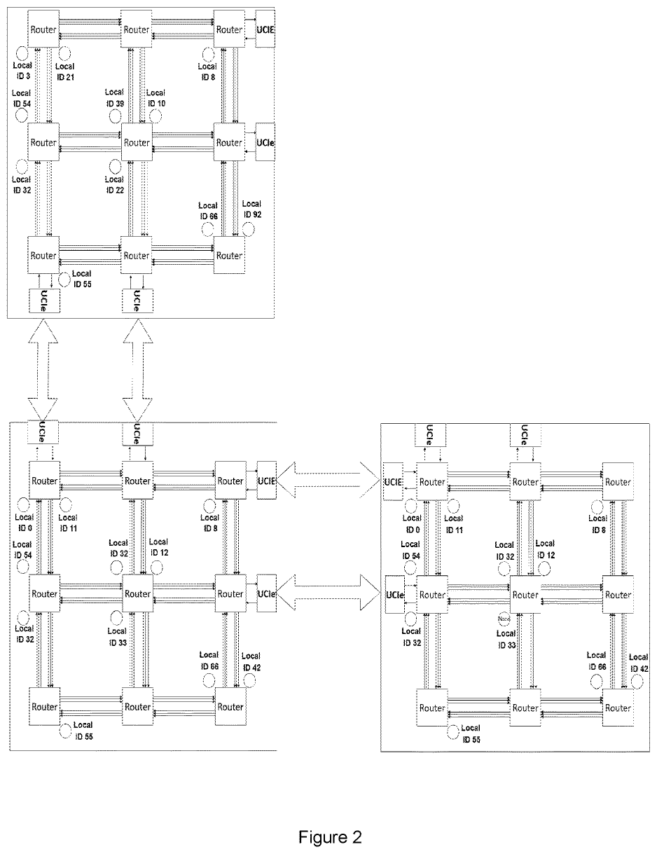

FIG. 2 shows the local ID assignment in a multi-die system composed of three dies. The local IDs uniquely identify a particular node within a single die. In contrast to interface IDs, local IDs may be assigned independently for each die without any knowledge of the local ID assignment of other dies in the multi-die system.

In accordance with an embodiment of the present invention, the method is applicable for routing a packet from an initiator node to a target node and returning the packet from the target node to the initiator node. Communication between the source and destination nodes generally begins with the initiator node sending a request packet to the target node Upon receiving this request, the target node responds with a status indicating whether the request was successfully serviced and any requested data.

In accordance with an embodiment of the present invention, the interface ID comprises the chiplet ID for identifying the chiplet, a link ID for identifying an inter-die interface between chiplet on an edge of the chiplet. The interface ID further comprises and edge ID for identifying the edge of the chiplet.

In accordance with an embodiment of the present invention, assigning the interface ID and the local ID to the packet is performed by any one of the methods selected from pin straps, fuses, firmware programming, or hardware table lookups. The interface ID and the local ID are attached with the packet while it is being routed in the multi-die SOC.

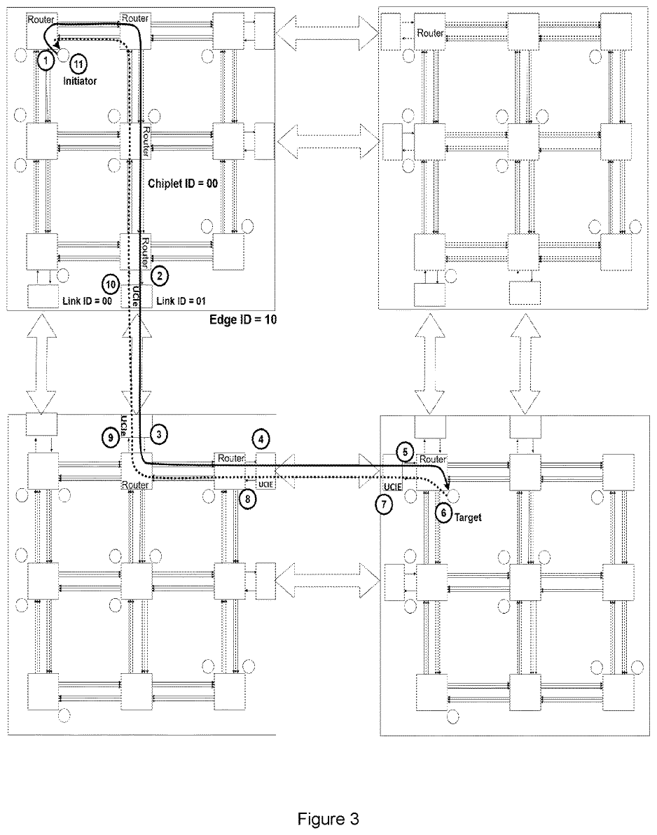

FIG. 3 shows the transaction between two nodes residing in different chiplet in accordance with an embodiment of the present invention. The solid curved arrow represents the path travelled by the request packet, while the dashed curved arrow shows the path of the response packet. Although the UCIE protocol is used as an example inter-die interconnect protocol in FIG. 3, the invention is not limited to any specific inter-die interconnect protocol.

Based on FIG. 3, the address of the request packet is used to lookup address routing tables at the Initiator, at point 1, and intermediate inter-die interconnects in the path between the Initiator and Target nodes by UCIE blocks at point 3 and point 5. Each address routing table lookup returns only enough routing information to route packets to its next immediate destination. The address routing table lookup at the Initiator at point 1 contains the routing information for the request packet to be routed to point 3. Subsequently the address routing table lookup at point 3 returns just enough information for the packet to be routed to the inter-die interconnect at point 5 and finally the address routing table lookup at point 5 returns the routing information required to route the packet to the Target node.

The interface ID, consisting of the chiplet ID, edge ID, and link ID, as well as the local ID of the Initiator node, is sent along with the request packet from the Initiator. These IDs are attached to the response packet and subsequently used for routing decisions when the response is returned from the Target node to the Initiator node. The interface ID may be attached to the request packet either at the Initiator node at point 1 or at the first inter-die interconnect points, at point 2 or point 3 encountered by the request packet. While the combination of chiplet ID and local ID uniquely identifies any node within a multi-die system, the inclusion of edge ID and link ID provides additional topological information to aid in routing decisions. The edge ID gives further details about the desired chiplet edge to which the packet should be routed, while the link ID specifies the exact inter-die interface on that edge to be used. As an example in FIG. 3, the interface ID value of the response packet is:

Interface ID={Chiplet ID,Edge ID,Link ID}={00,10,01}

On the return path, the initial routing table lookup is performed at the Target node using the attached interface ID or local ID. For intermediate chiplets that do not contain the Initiator node, gross routing may be performed. A possible implementation involves using a single entry in the Target node's routing table, at point 6 to route all response packets from the Target node to any Initiator node located in Chiplet 00. This is shown in Table 1 below. Because this routing entry is generalized, it can be reused for multiple Initiator-Target pairs, thereby helping to reduce the size of the routing table.

TABLE 1
ID Routing Table

| Chiplet ID | Edge ID | Link ID | Local ID | Routing Info |
|---|---|---|---|---|
| 00 | x | x | x | route to UCIE at |
| | | | | point 7, FIG. (3) |
| . . . | . . . | . . . | . . . | . . . |

The ID routing table first directs the NoC to route the packet to the UCIE interface at point 7. A subsequent ID routing table lookup at point 8 may involve a more detailed routing table, where the chiplet ID, edge ID, and link ID are used together to determine the routing information, as shown in Table 2.

TABLE 2
ID Routing Table

| Chiplet ID | Edge ID | Link ID | Local ID | Routing Info |
|---|---|---|---|---|
| 00 | 10 | 01 | x | route to UCIE at |
| | | | | point 9, FIG. (3) |
| . . . | . . . | . . . | . . . | . . . |

Finally, when the response packet reaches point 10, a final ID routing table lookup is performed using only the Local ID of the response packet. This lookup provides the necessary routing information to direct the packet back to the initiator at point 11.

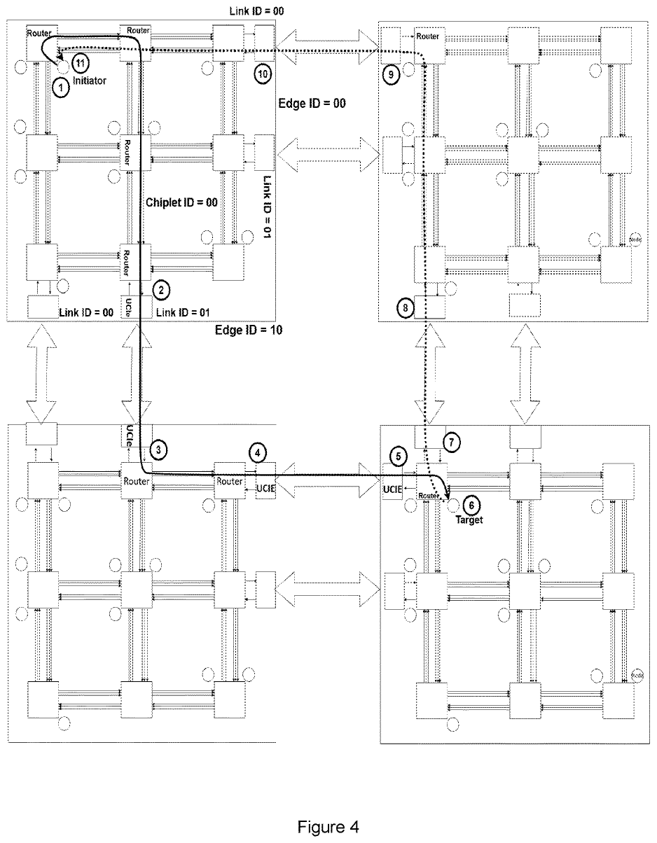

FIG. 4 shows the interface ID of the response packet for alternate return paths. In FIG. 4, the assigned interface ID of the response packet is {00, 00, 00}, in contrast to {00, 10, 01}, and the routing tables along the path are configured differently from those in FIG. 3.

In accordance with an embodiment of the present invention, the system for routing packets across multiple dies, comprising a plurality of chiplets, each interconnected by one or more inter-die communication interfaces, wherein each of the inter-die communication interfaces is identified by an interface identification (ID), a plurality of routers and nodes on each chiplet for receiving, forwarding, or routing packets, an interface ID routing table associated with each router or node, comprising entries that map ranges of interface IDs to routing information for forwarding packets to inter-die communication interfaces and a local ID routing table, associated with each router or node, comprising entries that map local IDs to routing information for routing packets to destination nodes within the chiplet.

In accordance with an exemplary embodiment of the present invention, the interface ID comprises a chiplet ID for identifying the chiplet, an edge ID for identifying an edge of the chiplet, and a link ID for identifying an inter-die interface between chiplet on the edge of the chiplet. The chiplet ID may comprise two sub-identifiers, configured to denote coordinates of the chiplet within the system.

The present invention provides a combination of IDs, which are chiplet ID, edge ID, link ID, and local ID. Each serving to uniquely identify different elements within a multi-chiplet system. The chiplet ID identifies a specific chiplet, the edge ID identifies edges on that chiplet, the link ID identifies an inter-die interface on a particular edge, and the local ID identifies local routes within a chiplet. A routing table construction utilizing all of these IDs together to minimize both the number of routing table entries and the size of each entry.

Conceptually, the chiplet ID, edge ID, link ID, and local ID form a hierarchical addressing scheme for multi-chiplet systems. Routing decisions for chiplets farther from the destination chiplet can be made broadly using just the chiplet ID. For chiplets closer to the destination, routing decisions may involve a combination of edge ID and/or link ID for more precise routing. Finally, once the packet reaches the destination chiplet, the local ID is used for the final routing step to the destination node within the chiplet. This approach enables significant reuse of routing table entries by multiple initiator-target node pairs, particularly in distant chiplets.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

1. A method for routing packets across multiple dies, comprising:
assigning an interface identification (ID) and a local ID to a packet at a source node, wherein the local ID corresponds to a destination node within a destination die, and the interface ID is used to identify an inter-die interface for routing the packet;
routing the packet to a receiving chiplet through the inter-die interface according to the interface ID;
checking if the receiving chiplet is the destination die by comparing chiplet IDs of the receiving die and the destination die;
a) if the receiving chiplet is not the destination die, using the interface ID of the packet to perform a lookup in an interface ID routing table, the table comprising ranges of Interface IDs and routing information for forwarding the packet to another inter-die interface;
routing the packet to a subsequent receiving die based on the routing information obtained from the interface ID routing table;
repeating checking if the receiving die is the destination die by comparing chiplet IDs of the receiving die and the destination die; and
b) if the receiving die is the destination die, using the local ID of the packet to perform a lookup in a local ID routing table, the table comprising local IDs and routing information for delivering the packet to the destination node;
routing the packet to the destination node based on the routing information obtained.

2. The method of claim 1, wherein the interface ID comprises the chiplet ID for identifying the chiplet, a link ID for identifying an inter-die interface between chiplet on an edge of the chiplet.

3. The method of claim 2, wherein the interface ID further comprises and edge ID for identifying the edge of the chiplet.

4. The method of claim 1, wherein assigning the interface ID and the local ID to the packet is performed by any one of the methods selected from pin straps, fuses, firmware programming, or hardware table lookups.

5. The method of claim 1, wherein the method is applicable for routing a packet from an initiator node to a target node and returning the packet from the target node to the initiator node.

6. A system for routing packets across multiple dies, comprising:
a plurality of chiplets, each interconnected by one or more inter-die communication interfaces;
wherein each of the inter-die communication interfaces is identified by an interface identification (ID);
a plurality of routers and nodes on each chiplet for receiving, forwarding, or routing packets;
an Interface ID routing table associated with each router or node, comprising entries that map ranges of interface IDs to routing information for forwarding packets to inter-die communication interfaces; and
a local ID routing table, associated with each router or node, comprising entries that map local IDs to routing information for routing packets to destination nodes within the chiplet.

7. The system of claim 6, wherein the interface ID comprises a chiplet ID for identifying the chiplet, an edge ID for identifying an edge of the chiplet, and a link ID for identifying an inter-die interface between chiplet on the edge of the chiplet.

8. The system of claim 7, wherein the chiplet ID comprises two sub-identifiers, configured to denote coordinates of the chiplet within the system.
